(19) United States
(12) Patent Application Publication
(10) Pub. No.: US 2026/0084316 A1
(43) Pub. Date: Mar. 26, 2026

(54) INFORMATION PROCESSING DEVICE, METHOD, AND SYSTEM

(71) Applicant: CASIO COMPUTER CO., LTD., Tokyo (JP)

(72) Inventor: Erina ICHIKAWA, Tokyo (JP)

(73) Assignee: CASIO COMPUTER CO., LTD., Tokyo (JP)

(21) Appl. No.: 19/338,868

(22) Filed: Sep. 24, 2025

(30) Foreign Application Priority Data
Sep. 24, 2024 (JP) 2024-165711

(51) Int. Cl. B25J 11/00; B25J 9/16

(52) U.S. Cl. CPC B25J 11/001; B25J 9/1674

(57) ABSTRACT

An information processing device includes a processor that executes processing including: storing, in a storage, management information in which robot identification information that identifies a robot device, owner identification information that identifies an owner of the robot device, and control data that changes due to interaction with the owner and causes the robot device to perform an action unique to the robot device are associated with one another; acquiring the robot identification information and the owner identification information; determining whether a combination of the robot identification information and the owner identification information that are acquired coincides with a combination of the robot identification information and the owner identification information that are included in the management information; and outputting, in a case where a determination of coincidence is made, the control data associated with the management information determined to coincide.

### CROSS-REFERENCE TO RELATED APPLICATIONS

This application claims the benefit of Japanese Patent Application No. 2024-165711, filed on Sep. 24, 2024, the entire disclosure of which is incorporated by reference herein.

### FIELD OF THE INVENTION

The present disclosure relates to an information processing device, a method, and a system.

### BACKGROUND OF THE INVENTION

Unexamined Japanese Patent Application Publication No. 2001-282570 discloses a technique in which a server is accessed to perform counseling or diagnosis on a pet robot in a manner similar to that for a living creature, and repair measures are taken if any abnormalities are detected in the personality or behavior of the pet robot.

### SUMMARY OF THE INVENTION

An information processing device according to the present disclosure includes a processor that executes processing including: storing, in a storage, management information in which robot identification information that identifies a robot device, owner identification information that identifies an owner of the robot device, and control data that changes due to interaction with the owner and causes the robot device to perform an action unique to the robot device are associated with one another; acquiring the robot identification information and the owner identification information; determining whether a combination of the robot identification information and the owner identification information that are acquired coincides with a combination of the robot identification information and the owner identification information that are included in the management information; and outputting, in a case where a determination of coincidence is made, the control data associated with the management information determined to coincide.

### BRIEF DESCRIPTION OF DRAWINGS

A more complete understanding of this application can be obtained when the following detailed description is considered in conjunction with the following drawings, in which:

FIG. 1 is a diagram illustrating a configuration of a robot management system according to an embodiment of the present disclosure;

FIG. 2A is a diagram illustrating a configuration of a robot device according to the embodiment;

FIG. 2B is a diagram illustrating a configuration of a user terminal device according to the embodiment;

FIG. 2C is a diagram illustrating a configuration of a maintenance terminal device according to the embodiment;

FIG. 2D is a diagram illustrating a configuration of a server according to the embodiment;

FIG. 3 is a diagram for a description of a flow of processing of uploading control data of the robot device to the server according to the embodiment;

FIG. 4 is a diagram illustrating a table of an interaction record that the robot device stores according to the embodiment;

FIG. 5A is a diagram illustrating a table of first management information that the server stores according to the embodiment;

FIG. 5B is a diagram illustrating a table of second management information that the server stores according to the embodiment;

FIG. 6A is a flowchart illustrating a process of robot control processing according to the embodiment;

FIG. 6B is a flowchart illustrating a process of restoration processing according to the embodiment;

FIG. 7 is a flowchart illustrating a process of user terminal device control processing according to the embodiment;

FIG. 8 is a flowchart illustrating a process of maintenance terminal device control processing according to the embodiment;

FIG. 9A is a flowchart illustrating a process of server control processing according to the embodiment; and

FIG. 9B is a flowchart illustrating a process of control data determination processing according to the embodiment.

### DETAILED DESCRIPTION OF THE INVENTION

A robot management system and the like according to an embodiment are described below with reference to the drawings. Note that the same or corresponding parts in the drawings are designated by the same reference numerals.

A robot management system 100 according to the embodiment is capable of retaining control data that represent a state to which a user, who is an owner, of a robot device 1 has raised the robot device 1, in a server 4. This allows for repairs to be carried out using control data including the relationship with the user as the owner, stored either in the robot device 1 or in the server 4, in an event of malfunction of the robot device 1. Accordingly, the robot device 1 can be repaired in a manner that takes into account its relationship with the user as the owner.

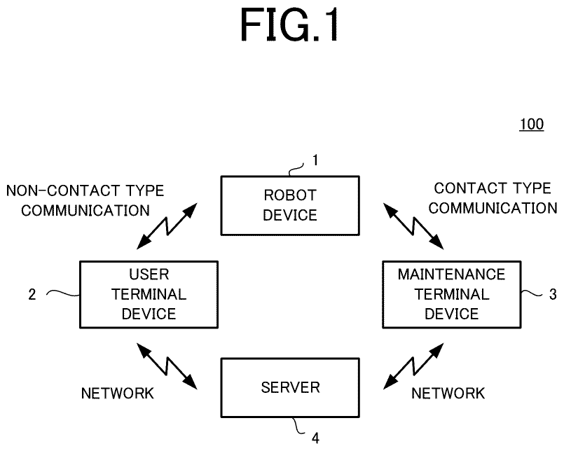

The robot management system 100 according to the embodiment includes the robot device 1, a user terminal device 2, the maintenance terminal device 3, and the server 4, as illustrated in FIG. 1. The robot device 1 is a pet robot that the user, who is an owner, raises as a guardian. Specifically, by the user treating the robot device 1 as if an owner treats a real pet by means of rubbing the robot device 1, talking to the robot device 1, or the like, the user and the robot device 1 communicate with each other and build a relationship between each other. The robot device 1 has a character as well as an emotion, and behavior of the robot device 1 changes due to not only an emotion but also a character. The emotions of the robot device 1 include an emotion that changes over a short period of time (for example, as long as several minutes to several hours) and an emotion that changes over a long period of time (for example, as long as several days to several years). In addition, the character of the robot device 1 changes according to a history of interactions with the user and a history of emotional changes. Thus, the control data to control the robot device 1 include information about an emotion and a character of the robot device 1 at the time. The user terminal device 2 is a terminal device that the user, who is the owner, of the robot device 1 uses. The user terminal device 2 is capable of communicating with the robot device 1 by non-contact type communication, such as Bluetooth (registered trademark) and infrared communication, and confirming a state of the robot device 1. In addition, the user terminal device 2 is capable of connecting to the server 4 via a network, and transmitting the state of the robot device 1 to the server 4 as control data and causing the server 4 to store the control data. The control data are data to be used for control to cause the robot device 1 to perform an action in accordance with an emotion and a character unique to an individual robot device 1 that the robot device 1 has nurtured through communication with the user. The maintenance terminal device 3 is a terminal device used by a staff in a customer service in charge of maintenance of the robot device 1. The maintenance terminal device 3 is capable of connecting to the server 4 via a network and acquiring control data stored in the server 4. In addition, the maintenance terminal device 3 is capable of performing contact type communication, such as universal serial bus (USB), with the robot device 1 and restoring the control data of the robot device 1 using the control data acquired from the server 4. The server 4 is connected to the user terminal device 2 and the maintenance terminal device 3 via a network, such as the Internet, Wi-Fi (registered trademark), and a wireless local area network (LAN). The server 4 is capable of storing the control data of the robot device 1 received from the user terminal device 2, and transmitting the stored control data to the maintenance terminal device 3.

The technique disclosed in Unexamined Japanese Patent Application Publication No. 2001-282570 does not allow for the retention of control data representing the state in which the user, as the owner, has raised the pet robot. Consequently, the pet robot cannot be restored to its state prior to repair.

The present disclosure is intended to address and solve the problem in such a situation, and an objective of the present disclosure is to provide a technique capable of retaining control data representing the state in which the user, as the owner, has raised the pet robot.

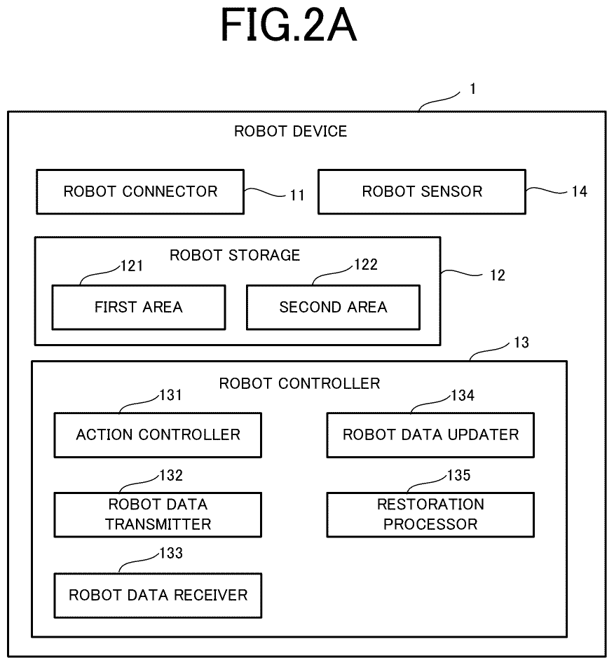

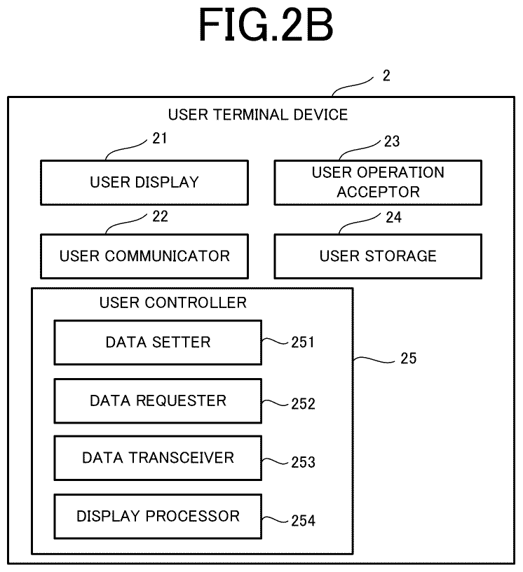

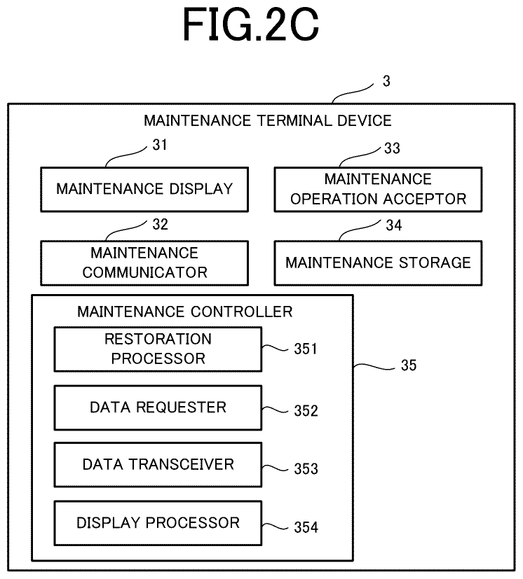

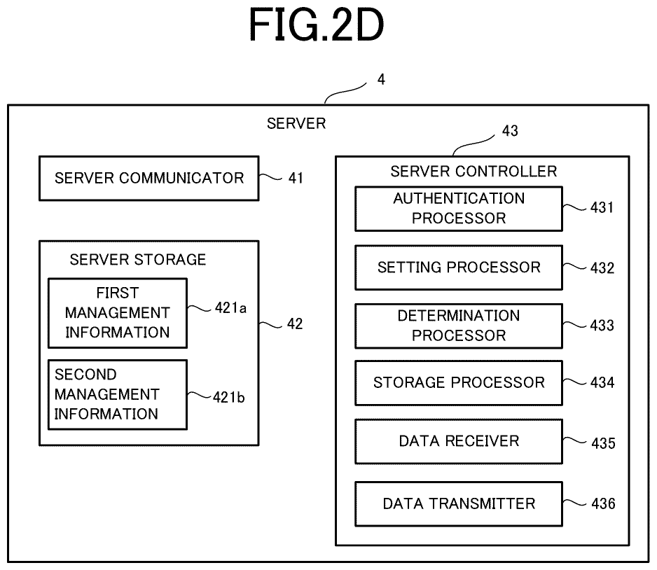

The robot device 1 includes a robot connector 11, a robot storage 12, a robot controller 13, and a robot sensor 14, as illustrated in FIG. 2A. The robot connector 11 is a connector that connects to the user terminal device 2 and the maintenance terminal device 3. The robot connector 11 is, for example, a connection terminal or a connection port capable of performing non-contact type communication, such as Bluetooth (registered trademark) and infrared communication, with the user terminal device 2. In addition, the robot connector 11 is a connection terminal or a connection port capable of performing contact type communication, such as USB, with the maintenance terminal device 3. The robot storage 12 stores various types of programs and various type of data used by the robot device 1. The robot storage 12 may include, for example, a random access memory (RAM), a read only memory (ROM), a flash memory, and the like, but not limited thereto. In addition, the robot storage 12 includes a first area 121 for storing control data and a second area 122 for backing up the control data stored in the first area 121. The robot controller 13 includes a processor, such as a central processing unit (CPU) and a digital signal processor (DSP). The robot controller 13 performs, by executing a program stored in the robot storage 12, various types of processing to cause the robot device 1 to act. For example, the robot controller 13 includes an action controller 131, a robot data transmitter 132, a robot data receiver 133, a robot data updater 134, and a restoration processor 135. The action controller 131 controls action of the robot device 1, using control data. The robot data transmitter 132 transmits control data to the user terminal device 2 via the robot connector 11. The robot data receiver 133 receives control data from the maintenance terminal device 3 via the robot connector 11. The robot data updater 134 updates action details of the robot device 1, which change due to contact with the user, as control data. The restoration processor 135 restores control data in the first area 121 in the robot storage 12, based on control data received from the maintenance terminal device 3. The robot sensor 14 is various types of sensors that detect interaction with the user, such as a contact sensor that senses contact from the user and a voice sensor that recognizes a voice of the user.

The user terminal device 2 includes a user display 21, a user communicator 22, a user operation acceptor 23, a user storage 24, and a user controller 25, as illustrated in FIG. 2B. The user display 21 can be configured using a display device, such as a liquid crystal display (LCD) and an organic electroluminescence (EL) display, and displays details of various types of processing executed by the user terminal device 2, such as state confirmation of the robot device 1 and acquisition of control data. The user communicator 22 is a communication interface through which the user terminal device 2 is communicable with the robot device 1 and the server 4. The user communicator 22 can be configured using a communication interface for non-contact type communication, such as Bluetooth (registered trademark), infrared communication, Wi-Fi (registered trademark), and a wireless local area network (LAN). The user operation acceptor 23 is a user interface, such as a push-button switch and a touch panel integrated with the user display 21, and accepts various types of operation input from the user. In addition, the user controller 25 is capable of acquiring what operation input the user performs, based on a detection result of the user operation acceptor 23. The user storage 24 stores various types of programs executed by the user controller 25 and data. The user storage 24 may include, for example, a RAM, a ROM, a flash memory, and the like, but not limited thereto. The user controller 25 includes a processor, such as a CPU and a DSP, and performs, by executing a program stored in the user storage 24, various types of processing executed by the user terminal device 2. The user controller 25 includes a data setter 251, a data requester 252, a data transceiver 253, and a display processor 254. The data setter 251 sets data for setting required for action of the robot device 1. The data requester 252 requests the robot device 1 for control data. The data transceiver 253 transmits and receives data to and from the robot device 1 and the server 4 via the user communicator 22. The display processor 254 displays various types of data including the state of the robot device 1 on the user display 21.

The maintenance terminal device 3 includes a maintenance display 31, a maintenance communicator 32, a maintenance operation acceptor 33, a maintenance storage 34, and a maintenance controller 35, as illustrated in FIG. 2C. The maintenance display 31 can be configured using a display device, such as an LCD and an organic EL display, and displays details of various types of processing executed by the maintenance terminal device 3, such as restoration and maintenance processing of control data of the robot device 1. The maintenance communicator 32 is a communication interface through which the maintenance terminal device 3 is communicable with the robot device 1 and the server 4, and can be configured using a communication interface for contact type communication, such as USB. The maintenance operation acceptor 33 is a user interface, such as a push-button switch and a touch panel integrated with the maintenance display 31, and accepts various types of operation input from the user. In addition, the maintenance controller 35 is capable of acquiring what operation input the user performs, based on a detection result of the maintenance operation acceptor 33. The maintenance storage 34 stores various types of programs executed by the maintenance controller 35 and data. The maintenance storage 34 may include, for example, a RAM, a ROM, a flash memory, and the like, but not limited thereto. The maintenance controller 35 includes a processor, such as a CPU and a DSP, and performs, by executing a program stored in the maintenance storage 34, various types of processing executed by the maintenance terminal device 3. The maintenance controller 35 includes a restoration processor 351, a data requester 352, a data transceiver 353, and a display processor 354. The restoration processor 351 executes processing to restore control data of the robot device 1. The data requester 352 requests the server 4 for control data. The data transceiver 353 transmits and receives data to and from the robot device 1 and the server 4 via the maintenance communicator 32. The display processor 354 displays various types of data on the maintenance display 31.

The server 4 includes a server communicator 41, a server storage 42, and a server controller 43, as illustrated in FIG. 2D. The server communicator 41 is a device that communicates with the user terminal device 2 and the maintenance terminal device 3 via the network, and can be configured using a communication port of, for example, Wi-Fi (registered trademark), a wireless LAN, or the like. That is, the server communicator 41 is provided with antennas such as Wi-Fi antennas and wireless LAN antennas. The communication port included in the server communicator 41 is not limited to wireless communication and may alternatively be configured to perform communication via a wired connection. The server storage 42 is a device that stores control data of the robot device 1 acquired from the user terminal device 2, various types of programs, data, and the like, and can be configured using a storage device such as a hard disk drive (HDD) and a solid state drive (SSD). In addition, the server storage 42 stores control data of the robot device 1 received from the user terminal device 2 as first management information 421a or second management information 421b. Note that hereinafter, the first management information 421a and the second management information 421b are collectively referred to as management information 421. In addition, details of the management information 421 are described later. The server controller 43 includes a processor, such as a CPU and a DSP, and performs, by executing a program stored in the server storage 42, various types of processing executed by the server 4. The server controller 43 includes an authentication processor 431, a setting processor 432, a determination processor 433, a storage processor 434, a data receiver 435, and a data transmitter 436. The authentication processor 431 authenticates a login from the user terminal device 2 or the maintenance terminal device 3. The setting processor 432 sets data for setting relating to processing executed by the server 4 and received from the user terminal device 2 or the maintenance terminal device 3. The determination processor 433 executes determination relating to storage and transmission and reception of control data. The storage processor 434 stores control data received from the user terminal device 2 in the server storage 42 as the management information 421. The data receiver 435 receives (acquires) control data from the user terminal device 2 via the antenna of the server communicator 41. The data transmitter 436 transmits (outputs) control data to the maintenance terminal device 3 via the antenna of the server communicator 41.

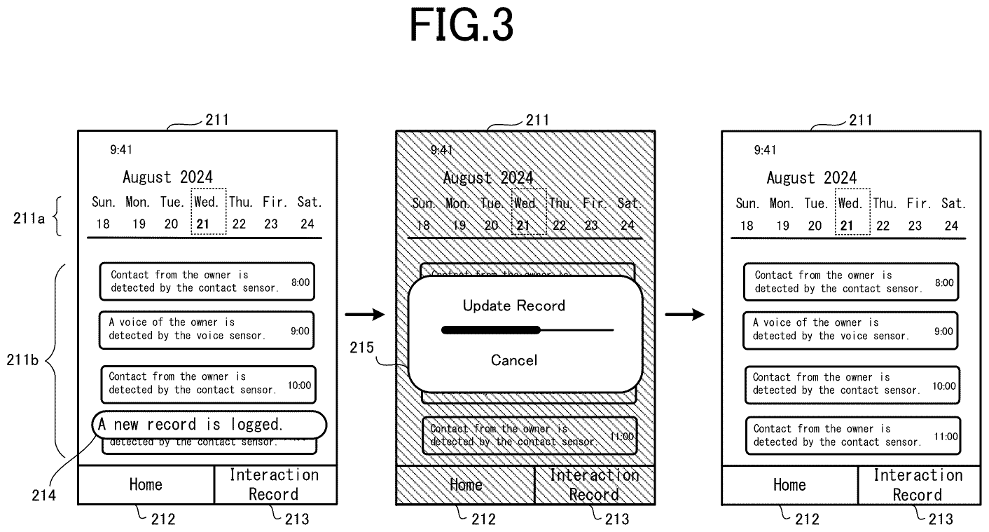

Next, a flow of processing of uploading the control data of the robot device 1 to the server 4, performed by the user terminal device 2, is described below with reference to FIG. 3. The drawings illustrated in FIG. 3 are an interaction record screen 211 displayed on the user display 21 of the user terminal device 2. The interaction record screen 211 is a screen that displays interaction records that are a history of the user, who is also the owner, of the robot device 1 having interacted and communicated with the robot device 1. First, in the leftmost drawing, the interaction record screen 211 includes dates 211a, an interaction timeline 211b, and a log acquisition button 214. The dates 211a indicate dates of displayed interaction records. The dates 211a are indicated on a weekly basis, and the user selects a date enclosed by a dotted line frame as a date the interaction records of which are to be displayed. The interaction timeline 211b displays a result of the robot sensor 14 of the robot device 1 illustrated in FIG. 2A detecting a situation of interaction between the robot device 1 and the user, who is the owner. For example, in FIG. 3, a record “Contact from the owner is detected by the contact sensor.” at time 8:00 and a record “A voice of the owner is detected by the voice sensor.” at time 9:00 are displayed. Below the interaction record screen 211, a home button 212 and an interaction record button 213 are arranged. The home button 212 is a button for transition to a home screen. The interaction record button 213 is a button for transition from another screen, such as the home screen, to the interaction record screen 211. For example, when the user presses the interaction record button 213 while the home screen is displayed, the user terminal device 2 communicates with the robot device 1 and acquires a log of a latest interaction record of the robot device 1. On this occasion, when there is a difference from a log of an interaction record acquired last time, under the assumption that there is a log of a new interaction record, in other words, the control data of the robot device 1 has been updated, the log acquisition button 214 is displayed on the interaction record screen 211 in a superimposing manner. The log acquisition button 214 is a button that is displayed when there is a log of a new interaction record.

When the user presses the log acquisition button 214, the interaction record screen 211 is grayed out and a record update dialog 215 is displayed as illustrated in the center drawing, and the user terminal device 2 uploads a log of an interaction record to the server 4. At the same time, the robot device 1 stores control data stored in the first area 121 in the robot storage 12 of the robot device 1 in the second area 122. Because of this configuration, control data can be backed up within the robot device 1. The record update dialog 215 includes a message to the effect that records are to be updated, a “cancel” button, and a progress bar indicating progress of upload of a log of an interaction record or the like. When the upload of the log of the interaction record to the server 4 and the storage of the control data in the second area 122 in the robot storage 12 of the robot device 1 are completed, the record update dialog 215 disappears and the graying out of the interaction record screen 211 terminates, as illustrated in the drawing on the right-hand side. In addition, the log acquisition button 214 disappears from the interaction record screen 211.

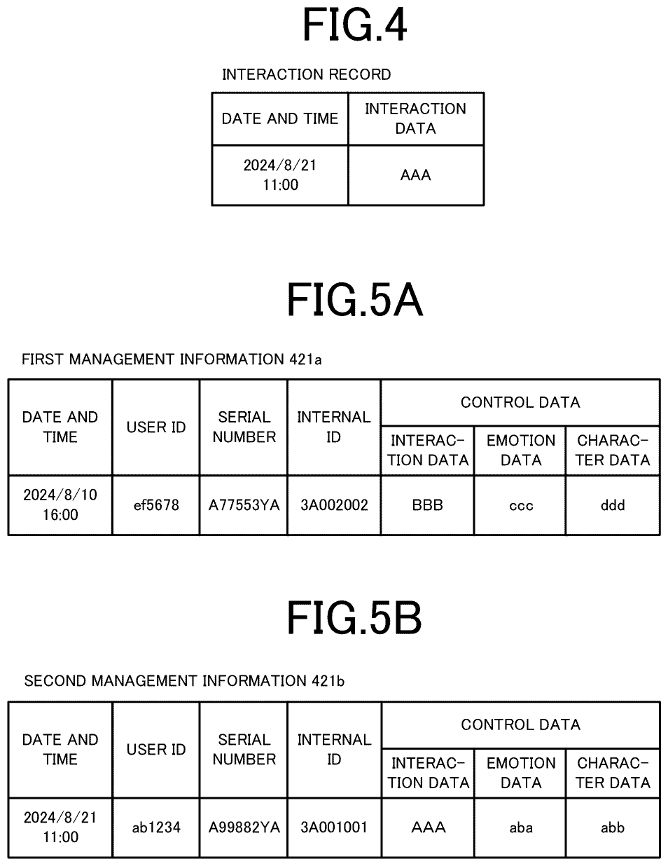

An interaction record that the user terminal device 2 acquires from the robot device 1 is data in which acquisition date and time are associated with interaction data, as illustrated in FIG. 4. In FIG. 4, for example, “2024/8/21 11:00” is entered in the date and time, and “AAA” is entered in the interaction data. When the user terminal device 2 transmits an interaction record to the server 4, the user terminal device 2 transmits a user identification (ID) stored in the user storage 24 and a serial number and an internal ID acquired from the robot device 1 in conjunction with the interaction record. In addition, when the user terminal device 2 transmits an interaction record, the user terminal device 2 acquires emotion data and character data from the robot device 1 in the background, where the user is not aware of the acquisition, and transmits the acquired emotion data and character data to the server 4. The emotion data, character data, and interaction data of the robot device 1 are data included in control data, in other words, transmitting the emotion data, the character data, and the interaction data to the server 4 enables the control data to be transmitted to the server 4. When the server 4 receives various types of data via the antenna from the user terminal device 2, the server 4 stores all the data in the server storage 42 in association with one another as the management information 421. The user ID is a unique ID that indicates the user and is used to log in to the user terminal device 2. The serial number is a unique number assigned to hardware of a body of the robot device 1. The internal ID is a unique ID that is assigned to software including control data of the robot device 1. In a case where the hardware of the body of the robot device 1 is required to be replaced in repair, although the serial number is changed, the internal ID, which is associated with software including control data, is not changed. Because of this configuration, the emotion and character of the robot device 1 that the user has nurtured can be maintained.

When the server 4 receives an interaction record, a user ID, and the like from the user terminal device 2, the server 4 stores all the data in the server storage 42 in association with one another as the management information 421. For example, tables of the first management information 421a and the second management information 421b stored in the server storage 42 are illustrated in FIGS. 5A and 5B, respectively. In each of the first management information 421a and the second management information 421b, date and time, a user ID, a serial number, an internal ID, and control data are associated with one another. The control data includes interaction data, emotion data, and character data. In FIG. 5A, for example, in the first management information 421a, “2024/8/10 16:00”, “ef5678”, “A77553YA”, and “3A002002” are entered in the date and time, the user ID, the serial number, and the internal ID, respectively, and “BBB”, “ccc”, and “ddd” are entered in the interaction data, the emotion data, and the character data of the control data, respectively. In addition, it is assumed that in the second management information 421b illustrated in FIG. 5B, the interaction data in the interaction record illustrated in FIG. 4 are entered. In this case, in the second management information 421b, “2024/8/21 11:00”, “ab1234”, “A99882YA”, and “3A001001” are entered in the date and time, the user ID, the serial number, and the internal ID, respectively, and “AAA”, “aba”, and “abb” are entered in the interaction data, the emotion data, and the character data of the control data, respectively. Note that the reason why in FIGS. 4, 5A, and 5B, “BBB” and “AAA”, “ccc” and “aba”, and “ddd” and “abb” are indicated in the interaction data, the emotion data, and the character data, respectively is to demonstrate, using symbols, that different data can be stored in each of the interaction data, the emotion data, and the character data, and the entries do not limit actual contents to be entered. For example, in the interaction data, parameter values such as the number of times that the robot device 1 has interacted with the user and intensity with which the user has touched the robot device 1 may be entered. In addition, data of parameters to indicate emotions, such as security level (anxiety level) and excitement level (apathy level), may be entered as the emotion data, and in a case where the excitement level is high, data indicating how the high excitement level influences the action of the robot device 1, such as increasing the activity frequency or the amount of activity of the robot device 1, may also be entered. In addition, data of parameters indicating being, for example, shy, cheerful, active, spoiled, or the like may be entered as the character data, and in a case where an activeness level is high, data indicating how the high activeness level influences change in the emotion, such as making change in the emotion more significant, may also be entered.

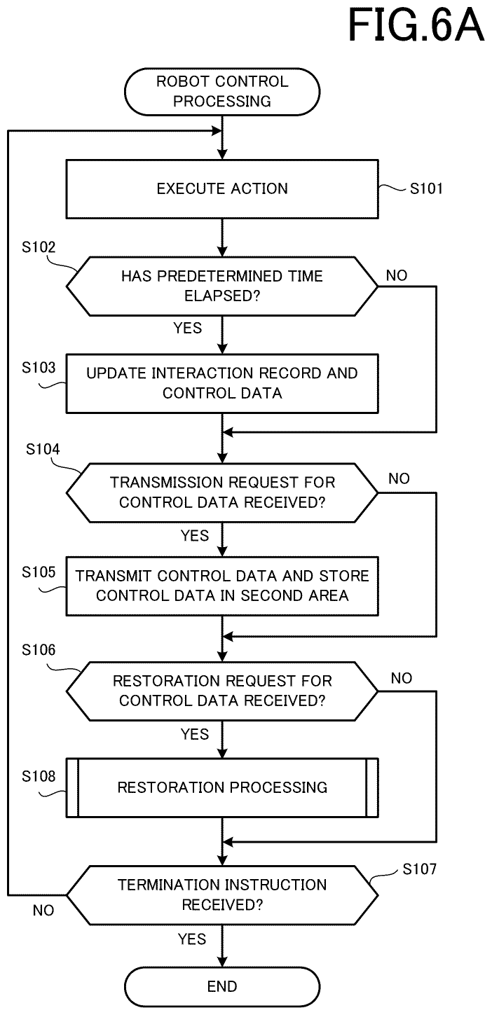

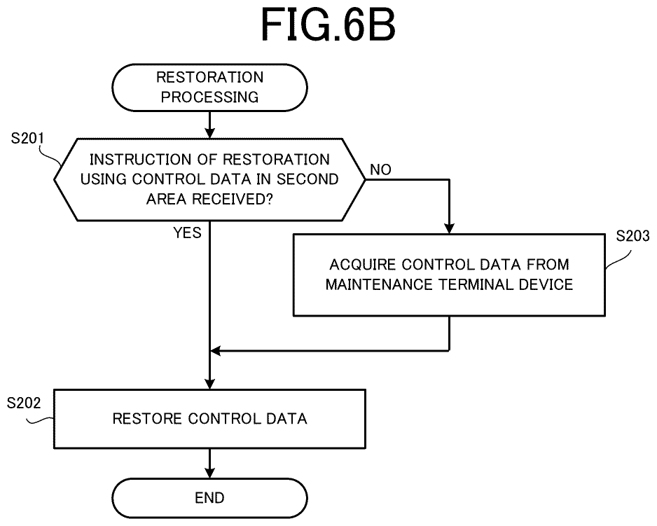

Next, processing executed by the robot device 1, the user terminal device 2, the maintenance terminal device 3, and the server 4 is described below with reference to flowcharts illustrated in FIGS. 6A to 11. First, it is assumed that robot control processing illustrated in FIG. 6A is stored in the robot storage 12 of the robot device 1 illustrated in FIG. 2A as a robot control processing program. When the robot device 1 is powered on and started up, the robot controller 13 reads in and executes the robot control processing program stored in the robot storage 12. A process of the robot control processing is described below with reference to a flowchart illustrated in FIG. 6A. The action controller 131 of the robot controller 13 in the robot device 1 illustrated in FIG. 2A drives a driving device installed inside the body of the robot device 1 and thereby executes the action of the robot device 1 (step S101). The robot data updater 134 of the robot controller 13 in the robot device 1 illustrated in FIG. 2A determines whether or not a predetermined period has elapsed (step S102). In the robot device 1, an interaction record is created periodically regardless of occurrence or non-occurrence of interaction with the user. In addition, in association with the creation of the interaction record, the robot data updater 134 updates the control data. Therefore, when the predetermined period has elapsed (step S102; YES), the robot data updater 134 updates the interaction record and the control data (step S103). In addition, when the predetermined period has not elapsed (step S102; NO), the robot data updater 134 proceeds to step S104. The robot data updater 134 determines whether or not a transmission request for control data has been received from the user terminal device 2 or the maintenance terminal device 3 (step S104). When a transmission request for control data has been received (step S104; YES), the robot data transmitter 132 of the robot controller 13 in the robot device 1 illustrated in FIG. 2A transmits the control data stored in the first area 121 in the robot storage 12 to the user terminal device 2 or the maintenance terminal device 3. In addition, the robot data transmitter 132 stores the control data stored in the first area 121 in the robot storage 12, in the second area 122 of the robot storage 12 (step S105). When no transmission request for control data has been received (step S104; NO), the process proceeds to step S106. The restoration processor 135 of the robot controller 13 in the robot device 1 illustrated in FIG. 2A determines whether or not a restoration request for control data has been received from the maintenance terminal device 3 (step S106). When a restoration request for control data has been received (step S106; YES), the restoration processor 135 executes restoration processing. A process of the restoration processing is described below with reference to a flowchart of the restoration processing illustrated in FIG. 6B. The restoration processor 135 determines whether or not an instruction to restore control data in the first area 121, using control data stored in the second area 122 in the robot storage 12 has been received from the maintenance terminal device 3 (step S201). When a restoration instruction using the control data stored in the second area 122 is received from the maintenance terminal device 3 (step S201; YES), the restoration processor 135 restores the control data in the first area 121, using the control data stored in the second area 122 (step S202). When no restoration instruction using the control data in the second area 122 has been received from the maintenance terminal device 3 (step S201; NO), the robot data receiver 133 of the robot controller 13 in the robot device 1 illustrated in FIG. 2A acquires control data from the maintenance terminal device 3 (step S203). The restoration processor 135 restores the control data in the first area 121, using the control data acquired in step S203 (step S202). The description now returns to FIG. 6A. When in step S106, no restoration request for control data has been received (step S106; NO), the action controller 131 determines whether or not a termination instruction has been received (step S107). For example, when the power of the robot device 1 is turned off, it is assumed that a termination instruction is received. When a termination instruction is received (step S107; YES), the action controller 131 terminates the robot control processing. When no termination instruction has been received (step S107; NO), the action controller 131 proceeds to step S101 and executes processing in and after step S101.

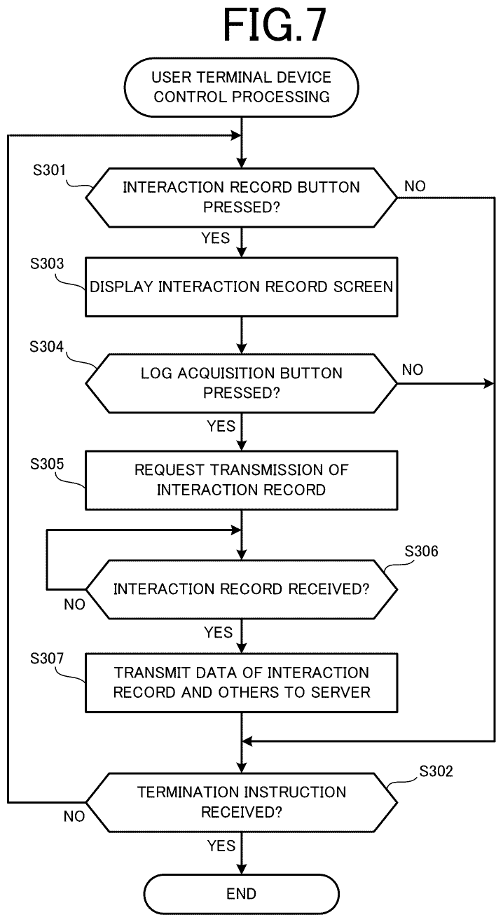

Next, processing executed by the user terminal device 2 is described. It is assumed that user terminal device control processing illustrated in FIG. 7 is stored in the user storage 24 of the user terminal device 2 illustrated in FIG. 2B as a user terminal device control processing program. When the user terminal device 2 starts communication with the robot device 1, the user controller 25 reads in and executes the user terminal device control processing program stored in the user storage 24. A process of the user terminal device control processing is described below with reference to a flowchart illustrated in FIG. 7. The data setter 251 of the user controller 25 in the user terminal device 2 illustrated in FIG. 2B determines whether or not the interaction record button 213 has been pressed in the home screen displayed on the user display 21 (step S301). When the interaction record button 213 has not been pressed (step S301; NO), the data setter 251 determines whether or not a termination instruction has been received (step S302). For example, when the user terminates the home screen, it is assumed that a termination instruction is received. When a termination instruction is received (step S302; YES), the data setter 251 terminates the user terminal device control processing. When no termination instruction has been received (step S302; NO), the data setter 251 proceeds to step S301 and executes processing in and after step S301. In addition, when the interaction record button 213 is pressed in step S301 (step S301; YES), the data setter 251 sets various types of data acquired from the robot device 1 and causes the display processor 254 to display the interaction record screen 211 on the user display 21 (step S303). For example, the display processor 254 displays on the user display 21 the screen on the left-hand side of FIG. 3. The data requester 252 of the user controller 25 in the user terminal device 2 illustrated in FIG. 2B determines whether or not the log acquisition button 214 has been pressed (step S304). When the log acquisition button 214 is pressed (step S304; YES), the data requester 252 requests the robot device 1 to transmit an interaction record illustrated in FIG. 4, which includes control data and date and time (step S305). In addition, when the log acquisition button 214 has not been pressed (step S304; NO), the data requester 252 executes step S302. The data transceiver 253 of the user controller 25 in the user terminal device 2 illustrated in FIG. 2B determines whether or not the data transceiver 253 has received an interaction record from the robot device 1 (step S306). When the data transceiver 253 has not received an interaction record from the robot device 1 (step S306; NO), the data transceiver 253 repeats step S306 until the data transceiver 253 receives an interaction record. When the data transceiver 253 receives an interaction record from the robot device 1 (step S306; YES), the data transceiver 253 transmits the received interaction record, a serial number and an internal ID acquired from the robot device 1, and a user ID stored in user storage 24 of the user terminal device 2 to the server 4. In addition, when the user terminal device 2 transmits the interaction record, the user terminal device 2 acquires emotion data and character data from the robot device 1 in the background and transmits the acquired emotion data and character data to the server 4 (step S307). The data setter 251 executes step S302.

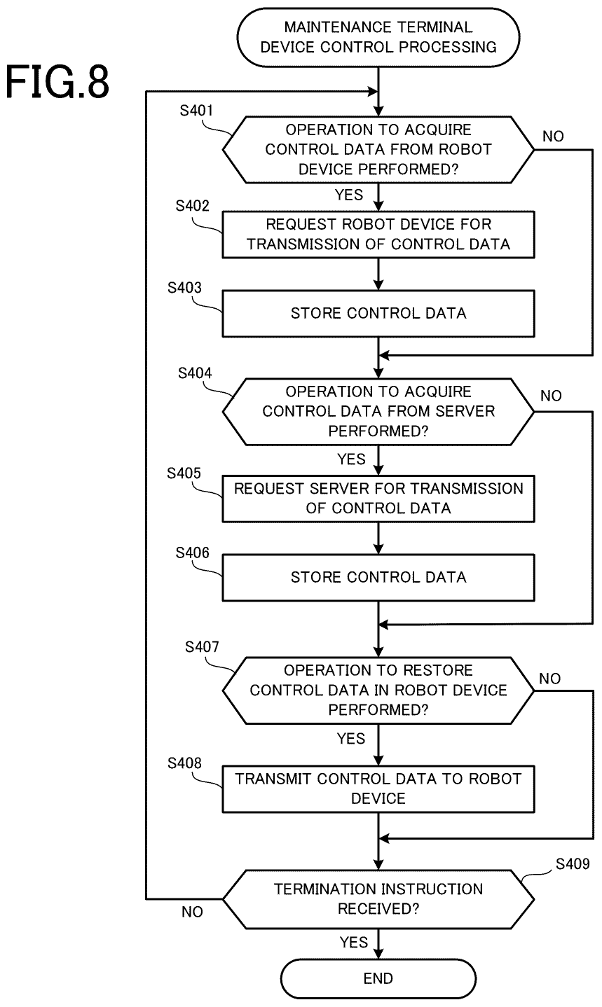

Next, processing executed by the maintenance terminal device 3 is described. It is assumed that maintenance terminal device control processing illustrated in FIG. 8 is stored in the maintenance storage 34 of the maintenance terminal device 3 illustrated in FIG. 2C as a maintenance terminal device control processing program. When the maintenance terminal device 3 starts communication with the robot device 1 by the contact type communication, such as USB, at the time of a malfunction of the robot device 1, the maintenance controller 35 reads in and executes the maintenance terminal device control processing program stored in the maintenance storage 34. A process of the maintenance terminal device control processing is described below with reference to a flowchart illustrated in FIG. 8. The data requester 352 of the maintenance controller 35 in the maintenance terminal device 3 illustrated in FIG. 2C determines whether or not an operation to acquire control data from the robot device 1 has been performed (step S401). When no operation to acquire control data from the robot device 1 has been performed (step S401; NO), the data requester 352 proceeds to step S404. When an operation to acquire control data from the robot device 1 is performed (step S401; YES), the data requester 352 requests the robot device 1 to transmit control data (step S402). The data requester 352 stores the received control data in the maintenance storage 34 illustrated in FIG. 2C (step S403). The data requester 352 determines whether or not an operation to acquire control data from the server 4 has been performed (step S404). When no operation to acquire control data from the server 4 has been performed (step S404; NO), the data requester 352 proceeds to step S407. When an operation to acquire control data from the server 4 is performed (step S404; YES), the data requester 352 requests the server 4 to transmit control data (step S405). The data requester 352 stores the received control data in the maintenance storage 34 illustrated in FIG. 2C (step S406). The restoration processor 351 of the maintenance controller 35 in the maintenance terminal device 3 illustrated in FIG. 2C determines whether or not an operation to restore the control data in the robot device 1, using the control data stored in the maintenance storage 34 in step S406 has been performed (step S407). When an operation to restore the control data in the robot device 1 is performed (step S407; YES), the restoration processor 351 transmits the control data stored in the maintenance storage 34 to the robot device 1 (step S408). When no operation to restore the control data in the robot device 1 has been performed (step S407; NO), the restoration processor 351 determines whether or not a termination instruction has been received (step S409). For example, when the user terminates communication with the robot device 1, it is assumed that a termination instruction is received. When a termination instruction is received (step S409; YES), the data requester 352 terminates the maintenance terminal device control processing. When no termination instruction has been received (step S409; NO), the data requester 352 proceeds to step S401 and executes processing in and after step S401.

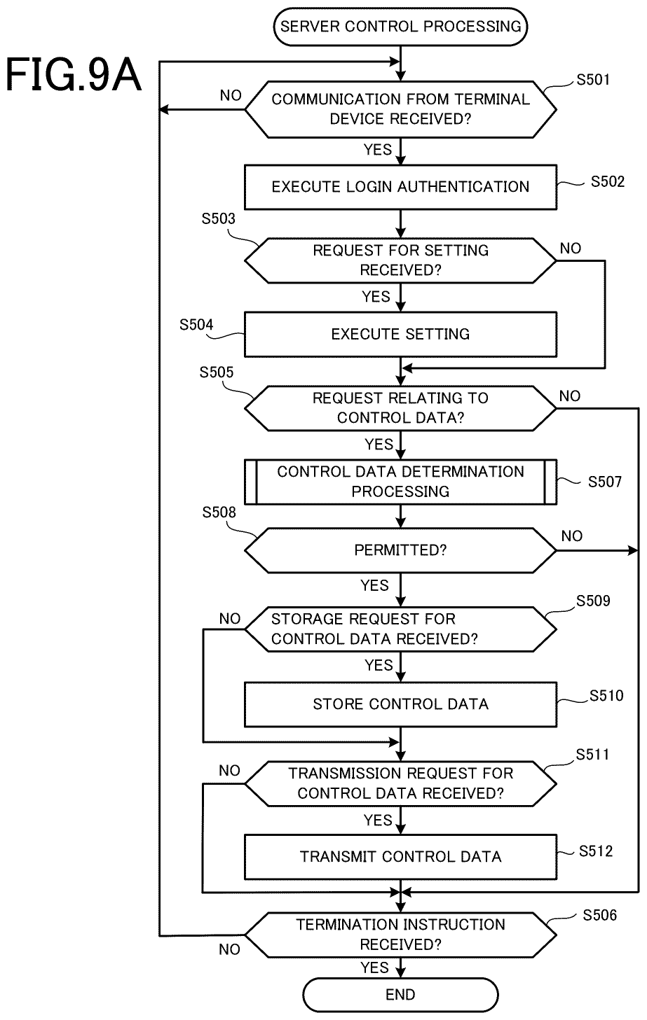

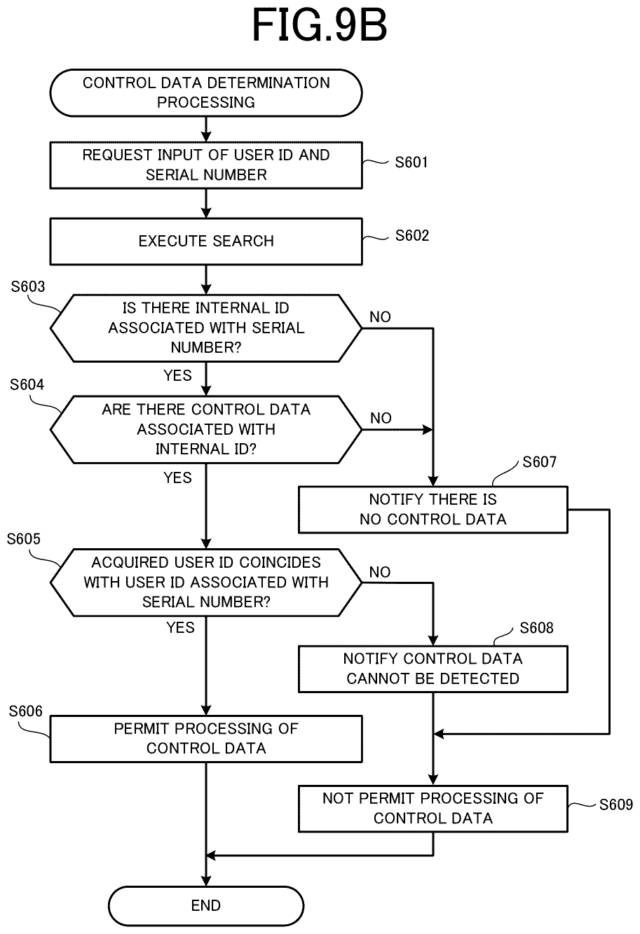

Next, processing executed by the server 4 is described. It is assumed that server control processing illustrated in FIG. 9A is stored in the server storage 42 of the server 4 illustrated in FIG. 2D as a server control processing program. When the server 4 is started up, the server controller 43 reads in and executes the server control processing program stored in the server storage 42. A process of the server control processing is described below with reference to a flowchart illustrated in FIG. 9A. The authentication processor 431 of the server controller 43 in the server 4 illustrated in FIG. 2D determines whether or not communication from the user terminal device 2 or the maintenance terminal device 3 has been received (step S501). When no communication from the user terminal device 2 or the maintenance terminal device 3 has been received (step S501; NO), the authentication processor 431 repeats step S501. When communication from the user terminal device 2 or the maintenance terminal device 3 is received (step S502; YES), the authentication processor 431 executes login authentication for the user terminal device 2 or the maintenance terminal device 3 (step S502). For example, the authentication processor 431 receives a user ID, which is to be stored in one of the first management information 421a and the second management information 421b, illustrated in FIGS. 5A and 5B, respectively, from the user terminal device 2 or the maintenance terminal device 3, and authenticates the user ID. The setting processor 432 of the server controller 43 in the server 4 illustrated in FIG. 2D determines whether or not a request for various types of settings has been received from the user terminal device 2 or the maintenance terminal device 3 (step S503). When no request for various types of settings has been received (step S503; NO), the setting processor 432 proceeds to step S505. When a request for various types of settings is received (step S503; YES), the setting processor 432 executes the various types of settings to the server 4 (step S504). The determination processor 433 of the server controller 43 in the server 4 illustrated in FIG. 2D determines whether or not a request relating to control data, such as transmission of control data, has been received from the user terminal device 2 or the maintenance terminal device 3 (step S505). When no request relating to control data has been received (step S505; NO), the determination processor 433 determines whether or not a termination instruction has been received (step S506). For example, when communication from the user terminal device 2 or the maintenance terminal device 3 is terminated, it is assumed that a termination instruction is received. When a termination instruction is received (step S506; YES), the determination processor 433 terminates the server control processing. When no termination instruction has been received (step S506; NO), the authentication processor 431 proceeds to step S501 and executes processing in and after step S501. When in step S505, a request relating to control data has been received (step S505; YES), the determination processor 433 executes control data determination processing (step S507).

A process of the control data determination processing is described below with reference to a flowchart illustrated in FIG. 9B. The determination processor 433 requests the user terminal device 2 or the maintenance terminal device 3 to input the user ID and the serial number of the robot device 1 (step S601). The determination processor 433 executes a search for control data associated with the user ID and the serial number acquired in step S601 (step S602). Specifically, the determination processor 433 searches the first management information 421a and the second management information 421b, which are stored in the server storage 42 of the server 4 illustrated in FIG. 2D and include a user ID and a serial number, to determine whether or not the user ID and the serial number acquired in step S601 is included in the first management information 421a or the second management information 421b. The determination processor 433 searches the first management information 421a and the second management information 421b stored in the server storage 42 with the serial number acquired in step S601 and determines whether or not an internal ID associated with the serial number is included in the first management information 421a or the second management information 421b (step S603). When an internal ID associated with the serial number is included (step S603; YES), the determination processor 433 determines whether or not control data associated with the internal ID are included in the first management information 421a or the second management information 421b (step S604). When control data associated with the internal ID are included (step S604; YES), the determination processor 433 determines whether or not the user ID acquired in step S601 coincides with the user ID associated with the serial number in the first management information 421a or the second management information 421b (step S605). When the user IDs coincide with each other (step S605; YES), the determination processor 433 permits processing relating to the control data (step S606). Therefore, when a combination of the user ID and the serial number input from the user terminal device 2 or the maintenance terminal device 3 in step S601 coincides with a combination of the user ID and the serial number included in the management information 421 in the server storage 42, the processing relating to the control data is permitted. In addition, when there is no internal ID associated with the serial number in step S603 (step S603; NO) and when there are no control data associated with the internal ID in step S604 (step S604; NO), the determination processor 433 notifies the user terminal device 2 or the maintenance terminal device 3 that there are no control data (step S607). In addition, when in step S605, the user IDs do not coincide with each other (step S605; NO), the determination processor 433 notifies the user terminal device 2 or the maintenance terminal device 3 that no control data can be detected (step S608). The determination processor 433 does not permit the processing relating to the control data (step S609). The determination processor 433 terminates the control data determination processing.

The description now returns to FIG. 9A. The determination processor 433 determines whether or not the processing relating to control data is permitted (step S508). When the processing relating to control data is not permitted (step S508; NO), the determination processor 433 executes step S506. When the processing relating to control data is permitted (step S508; YES), the determination processor 433 determines whether or not a storage request for the control data has been received from the user terminal device 2 (step S509). When no storage request for the control data has been received (step S509; NO), the determination processor 433 proceeds to step S511. When a storage request for the control data is received (step S509; YES), the data receiver 435 of the server controller 43 in the server 4 illustrated in FIG. 2D receives the control data from the user terminal device 2. The storage processor 434 of the server controller 43 stores the received control data in the server storage 42 in association with the date and time, the user ID, and the like as the management information 421 (step S510). The determination processor 433 determines whether or not a transmission request for the control data has been received from the maintenance terminal device 3 (step S511). When no transmission request for the control data has been received from the maintenance terminal device 3 (step S511; NO), the determination processor 433 executes step S506. When a transmission request for the control data is received from the maintenance terminal device 3 (step S511; YES), the determination processor 433 transmits the control data to the maintenance terminal device 3 (step S512). The determination processor 433 executes step S506.

As described above, the robot management system 100 according to the embodiment is capable of retaining control data that represent a state to which the user, who is the owner, of the robot device 1 has raised the robot device 1, in the server 4. This allows for repairs to be carried out using control data including the relationship with the user as the owner, stored either in the robot device 1 or in the server 4, in an event of malfunction of the robot device 1. Accordingly, the robot device 1 can be repaired in a manner that takes into account its relationship with the user as the owner.

### Other Variations

Note that although in the above-described embodiment, in the restoration processing illustrated in FIG. 6B, whether the control data in the first area 121 in the robot storage 12 of the robot device 1 is restored using the control data in the second area 122 in the robot storage 12 or restored using the control data received from the server 4 is determined by an instruction from the maintenance terminal device 3, the determination may be made depending on a type of service to be provided to the user. For example, the restoration of the control data in the first area 121 using the control data in the second area 122 of the robot storage 12 may be provided as a free service, and the restoration of the control data in the first area 121 using the control data received from the server 4 may be provided as a paid service. In addition, it may be configured to be able to restore the control data in the robot storage 12 by providing a dedicated maintenance tool that is different from the maintenance terminal device 3.

In addition, although in the above-described embodiment, the robot device 1, the user terminal device 2, and the maintenance terminal device 3 are configured as separate entities, it may be configured such that one or both of functions of the user terminal device 2 and the maintenance terminal device 3 may be incorporated into the robot device 1 and the robot device 1 is capable of functioning as the user terminal device 2 and the maintenance terminal device 3. In addition, it may be configured such that one of the user terminal device 2 and the maintenance terminal device 3 performs the function of the server 4.

In addition, although in the above-described embodiment, control data are transmitted from the server 4 to the maintenance terminal device 3, it may be configured such that information about date and time is transmitted in conjunction with control data and the user can select control data of arbitrary date and time. In addition, in a case where the user selects control data, confirmation information indicating that the user selects control data of arbitrary date and time may be transmitted from the maintenance terminal device 3 to the server 4.

In addition, although in the above-described embodiment, the robot device 1 is assumed not to be connected to the network, the robot device 1 may be connected to the network. In this case, the robot device 1 may directly communicate with the server 4 without involving the user terminal device 2 and the maintenance terminal device 3.

In addition, although in the above-described embodiment, the robot device 1 is assumed to have control data restored by the maintenance terminal device 3, the control data may be restored by an information processing device, such as a personal computer (PC), a tablet, a terminal, or the like placed in a store. The robot device 1 may perform contact type communication with the information processing device via a cable or the like or may perform non-contact type communication through a network.

In addition, although in the above-described embodiment, the robot data updater 134 of the robot device 1 is assumed to update interaction records and control data after a lapse of a predetermined time, the present disclosure is not limited to such a configuration, and interaction records and control data may be updated when the robot device 1 exhibits a change in an emotion or a character due to interaction with the user.

In addition, the user terminal device 2 and the maintenance terminal device 3 can also be achieved by not only a smartphone but also a computer, such as a tablet and a PC, that is communicable with the robot device 1 and the server 4. For example, a computer capable of executing the above-described respective pieces of processing may be configured by storing programs that the user controller 25 of the user terminal device 2 and the maintenance controller 35 of the maintenance terminal device 3 execute in a non-transitory computer-readable recording medium, such as a flexible disk, a compact disc read only memory (CD-ROM), a digital versatile disc (DVD), a magneto-optical disc (MO), a memory card, and a USB memory, and distributing the non-transitory recording medium and reading and installing the programs in the computer.

Further, it is also possible to superimpose a program on a carrier wave and apply the program via a communication medium, such as the Internet. For example, the program may be posted on a bulletin board system (BBS) on a communication network and distributed via the communication network. It may be configured such that the above-described processing can be executed by starting up and executing the distributed program in a similar manner to other application programs under the control of an operating system (OS).

In addition, the user controller 25 of the user terminal device 2 and the maintenance controller 35 of the maintenance terminal device 3 may be configured not only by an arbitrary processor, such as a single processor, multiprocessors, and a multi-core processor, alone but also by combining such an arbitrary processor and a processing circuit, such as an application specific integrated circuit (ASIC) and a field-programmable gate array (FPGA).

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An information processing device comprising:
a processor that executes processing including:
storing, in a storage, management information in which robot identification information that identifies a robot device, owner identification information that identifies an owner of the robot device, and control data that changes due to interaction with the owner and causes the robot device to perform an action unique to the robot device are associated with one another;
acquiring the robot identification information and the owner identification information;
determining whether a combination of the robot identification information and the owner identification information that are acquired coincides with a combination of the robot identification information and the owner identification information that are included in the management information; and
outputting, in a case where a determination of coincidence is made, the control data associated with the management information determined to coincide.

2. The information processing device according to claim 1, wherein
the robot identification information identifies hardware of the robot device, and
the control data are associated with internal identification information that identifies software of the robot device.

3. The information processing device according to claim 2, wherein
the management information further includes the internal identification information and associates the owner identification information with the control data via the internal identification information.

4. The information processing device according to claim 1, wherein
the control data are data to cause the robot device to act in such a manner that the robot device has a unique emotion or a unique character to the robot device and are data that change due to communication between the owner and the robot device.

5. The information processing device according to claim 3, wherein
the control data are data to cause the robot device to act in such a manner that the robot device has a unique emotion or a unique character to the robot device and are data that change due to communication between the owner and the robot device.

6. The information processing device according to claim 4, wherein
acquisition of the robot identification information and the owner identification information is performed by receiving the robot identification information and the owner identification information via an antenna,
determination of the whether or not a combination of the robot identification information and the owner identification information that are acquired coincides with a combination of the robot identification information and the owner identification information that are included in the management information is performed by determining whether a combination of the robot identification information and the owner identification information that are received via the antenna coincides with the combination of the robot identification information and the owner identification information that are included in the management information, and
storage in the storage is performed by storing, in a case where a determination of coincidence is made, the control data received via the antenna.

7. The information processing device according to claim 5, wherein
acquisition of the robot identification information and the owner identification information is performed by receiving the robot identification information and the owner identification information via an antenna,
determination of the whether or not a combination of the robot identification information and the owner identification information that are acquired coincides with a combination of the robot identification information and the owner identification information that are included in the management information is performed by determining whether a combination of the robot identification information and the owner identification information that are received via the antenna coincides with the combination of the robot identification information and the owner identification information that are included in the management information, and
storage in the storage is performed by storing, in a case where a determination of coincidence is made, the control data received via the antenna.

8. The information processing device according to claim 1, wherein
the storage stores a plurality of pieces of the management information, and
the determination of the whether or not a combination of the robot identification information and the owner identification information that are acquired coincides with a combination of the robot identification information and the owner identification information that are included in the management information is performed by determining whether the robot identification information and the owner identification information that are received via the antenna are included in one of the plurality of pieces of the management information.

9. The information processing device according to claim 3, wherein
the storage stores a plurality of pieces of the management information, and
the determination of the whether or not a combination of the robot identification information and the owner identification information that are acquired coincides with a combination of the robot identification information and the owner identification information that are included in the management information is performed by determining whether the robot identification information and the owner identification information that are received via the antenna are included in one of the plurality of pieces of the management information.

10. The information processing device according to claim 6, wherein
the storage stores a plurality of pieces of the management information, and
the determination of the whether or not a combination of the robot identification information and the owner identification information that are acquired coincides with a combination of the robot identification information and the owner identification information that are included in the management information is performed by determining whether the robot identification information and the owner identification information that are received via the antenna are included in one of the plurality of pieces of the management information.

11. The information processing device according to claim 8, wherein
output of the control data is performed, in a case where a result of the determination of the whether or not a combination of the robot identification information and the owner identification information that are acquired coincides with a combination of the robot identification information and the owner identification information that are included in the management information indicates that the robot identification information and the owner identification information are included in one of the plurality of pieces of the management information, by transmitting the control data associated with the robot identification information and the owner identification information by the management information, via the antenna and, in a case where a result of the determination of the whether or not a combination of the robot identification information and the owner identification information that are acquired coincides with a combination of the robot identification information and the owner identification information that are included in the management information indicates that the robot identification information and the owner identification information are not included in one of the plurality of pieces of the management information, by transmitting a message to an effect that there is no control data to be restored, via the antenna.

12. The information processing device according to claim 9, wherein
output of the control data is performed, in a case where a result of the determination of the whether or not a combination of the robot identification information and the owner identification information that are acquired coincides with a combination of the robot identification information and the owner identification information that are included in the management information indicates that the robot identification information and the owner identification information are included in one of the plurality of pieces of the management information, by transmitting the control data associated with the robot identification information and the owner identification information by the management information, via the antenna and, in a case where a result of the determination of the whether or not a combination of the robot identification information and the owner identification information that are acquired coincides with a combination of the robot identification information and the owner identification information that are included in the management information indicates that the robot identification information and the owner identification information are not included in one of the plurality of pieces of the management information, by transmitting a message to an effect that there is no control data to be restored, via the antenna.

13. The information processing device according to claim 10, wherein
output of the control data is performed, in a case where a result of the determination of the whether or not a combination of the robot identification information and the owner identification information that are acquired coincides with a combination of the robot identification information and the owner identification information that are included in the management information indicates that the robot identification information and the owner identification information are included in one of the plurality of pieces of the management information, by transmitting the control data associated with the robot identification information and the owner identification information by the management information, via the antenna and, in a case where a result of the determination of the whether or not a combination of the robot identification information and the owner identification information that are acquired coincides with a combination of the robot identification information and the owner identification information that are included in the management information indicates that the robot identification information and the owner identification information are not included in one of the plurality of pieces of the management information, by transmitting a message to an effect that there is no control data to be restored, via the antenna.

14. The information processing device according to claim 3, wherein
the management information is stored with information about date and time of acquisition of the control data associated with the control data.

15. The information processing device according to claim 5, wherein
the management information is stored with information about date and time of acquisition of the control data associated with the control data.

16. The information processing device according to claim 14, wherein
output of the control data is performed by transmitting the information about date and time included in the management information the robot identification information and the owner identification information in which coincide with a pair of the robot identification information and the owner identification information coincides, via the antenna.

17. The information processing device according to claim 16, wherein
acquisition of the robot identification information and the owner identification information is performed by acquiring confirmation information, based on the information about date and time, and
output of the control data is performed by transmitting the control data associated with the management information, based on the confirmation information, via the antenna.

18. The information processing device according to claim 4, wherein
the control data include at least one of emotion data representing the unique emotion of the robot device, character data representing the unique character of the robot device, or interaction data,
behavior of the robot device changes due to the unique emotion and the unique character,
the unique emotion of the robot device changes as time passes, and
the unique character of the robot device changes according to a history of interactions with a user or a history of emotional changes.

19. An information processing method to be executed by an information processing device including a processor and a memory, the information processing method comprising:
storing, by the processor, robot identification information that identifies a robot device, owner identification information that identifies an owner of the robot device, and control data that changes due to interaction with the owner and causes the robot device to perform an action unique to the robot device in association with one another as management information;
acquiring, by the processor, the robot identification information and the owner identification information;
determining, by the processor, whether or not a combination of the robot identification information and the owner identification information that are acquired coincides with a combination of the robot identification information and the owner identification information that are included in the management information; and
outputting, by the processor, in a case where a determination of coincidence is made, the control data associated with the management information determined to coincide.

20. A system comprising:
a robot device; and
an information processing device that is connected to a terminal device communicating with the robot device, via a network, wherein
the information processing device includes a processor, and
the processor executes processing including:
storing robot identification information that identifies the robot device, owner identification information that identifies an owner of the robot device, and control data that changes due to interaction with the owner and causes the robot device to perform an action unique to the robot device in association with one another as management information;
acquiring the robot identification information and the owner identification information;
determining whether a combination of the robot identification information and the owner identification information that are acquired coincides with a combination of the robot identification information and the owner identification information that are included in the management information; and
transmitting, in a case where a determination of coincidence is made, the control data associated with the management information determined to coincide.
